(19) United States
(12) Patent Application Publication
(10) Pub. No.: US 2021/0188592 A1
(43) Pub. Date: Jun. 24, 2021

(54) METHOD AND ELEVATOR CONTROLLER FOR CONTROLLING AN ELEVATOR GROUP HAVING A PLURALITY OF ELEVATORS ON THE BASIS OF DESTINATION CALLS

(71) Applicant: Inventio AG, Hergiswil (CH)

(72) Inventor: Stefano Caroni, Cadro (CH)

(21) Appl. No.: 16/757,829

(22) PCT Filed: Nov. 27, 2018
(86) PCT No.: PCT/EP2018/082666

§ 371 Date: Apr. 21, 2020

(30) Foreign Application Priority Data
Dec. 21, 2017 (EP) 17209813.9

(51) Int. Cl. B66B 1/24

(52) U.S. Cl. CPC B66B 1/2458; B66B 2201/103; B66B 2201/235; B66B 2201/216; B66B 2201/215

(57) ABSTRACT

A method for controlling an elevator group having a plurality of elevators based upon user generated destination calls includes: receiving a destination call containing information regarding the waiting floor on which an associated user is waiting and the destination floor to which the user should be transported; waiting for a delay time period; assigning a service elevator from the plurality of elevators after the delay time period has passed and controlling the service elevator to pick up the user on the waiting floor and transport the user to the destination floor. Because the service elevator is calculated and assigned only after the delay time period has expired, and because further destination calls received during the delay time period are also taken into consideration, the assignment of service elevators can be made more efficient and more appropriate to the situation and waiting times for users can be reduced on average.

### FIELD

The present invention relates to a method for controlling an elevator group that comprises a plurality of elevators. The invention furthermore relates to an elevator controller that is configured for carrying out the proposed method, an elevator group that is equipped with such an elevator controller, a computer program product, as well as a machine-readable medium with such a computer program product.

### BACKGROUND

Elevators serve for respectively transporting users or passengers between different height levels or between different floors within structures or buildings. Very large buildings, in particular, are usually equipped with elevator groups, in which a plurality of elevators is used for transporting large numbers of users within the building. The elevators of such an elevator group usually are coordinated by a controller that is assigned to the entire elevator group, wherein the controller attempts to control and move the different elevators in such a way that a transport capacity of the entire elevator group is maximized and/or waiting times for the users are minimized.

Elevator groups have been developed, in which a user arriving on a floor not merely calls an elevator by informing the elevator group of his waiting floor, e.g. by pressing a button. Instead, the user also informs the elevator group of the destination floor, to which he would like to be transported. Furthermore, the controller of the elevator group can take such additional information on the destination floor into account in purposefully determining which of the elevators of the elevator group should undertake the transport of the user, e.g. by taking into account if other users have previously indicated an identical or nearby destination floor such that a common elevator, which is herein referred to as service elevator below, is assigned to users with the same or a similar destination floor. Such a method for controlling elevator groups is referred to as “destination call control” and described, for example, in EP 0 356 731 B1, EP 0 891 291 B1 and EP 1 276 691 B1.

However, it was observed that an assignment of elevators of an elevator group to waiting users with the aid of a conventional destination call control does not appear to be optimal in all instances, particularly in very large and tall buildings.

Among other things, there may be a demand for a method for controlling an elevator group, in which a capacity utilization of all elevators of the elevator group can be further optimized and a transport capacity or transport efficiency of the elevator group can thereby be increased and/or in which waiting times for the users of the elevator group can be reduced. This makes it possible to improve a user satisfaction, to lower an energy consumption and/or to reduce wear on the elevator group. There may furthermore be a demand for a correspondingly configured elevator controller and an elevator group equipped therewith, as well as for a computer program product that is configured for carrying out the method and a machine-readable medium provided therewith.

### SUMMARY

Such a demand can be met with the advantageous embodiments defined in the following description.

According to an aspect of the invention, a method for controlling an elevator group having a plurality of elevators on the basis of destination calls is proposed, wherein said destination calls are to be transmitted by users to the elevator group. The method comprises at least the following steps, preferably in the specified sequence: (i) receiving a destination call, which contains at least information regarding a waiting floor, on which a user sending the destination call is waiting, and regarding a destination floor, to which the user should be transported; (ii) waiting for a delay time period; and (iii), assigning a service elevator from the plurality of elevators after the delay time period has expired and controlling the service elevator so as to pick up the user on the waiting floor and transport the user to the destination floor. In this case, the service elevator is assigned with consideration of information contained in destination calls that are received during the delay time period.

A second aspect of the invention concerns an elevator controller for controlling an elevator group having a plurality of elevators, wherein said elevator controller is configured for carrying out or controlling a method according to an embodiment of the first aspect of the invention.

A third aspect of the invention concerns an elevator group that comprises an elevator controller according to an embodiment of the second aspect of the invention.

A fourth aspect of the invention concerns a computer program product containing machine-readable instructions, which upon execution on a programmable device prompt this programmable device to carry out a method according to an embodiment of the first aspect of the invention.

A fifth aspect of the invention concerns a machine-readable medium, on which a computer program product according to an embodiment of the fourth aspect of the invention is stored.

Potential characteristics and advantages of embodiments of the invention may, among other things, be considered to be based on the ideas and realizations described below without thereby restricting the invention.

As initially mentioned, conventional methods, in which the assignment of a service elevator from a plurality of elevators to a user was carried out with consideration of the destination call transmitted by the user, lead at least in some instances to a non-optimal assignment of the available elevators to the users to be transported. This can negatively affect a transport efficiency of the elevator group, a transport capacity of the elevator group and/or waiting and transport times for the users.

As a potential measure for reducing such negative effects, it is now proposed to no longer carry out the assignment of a service elevator to a waiting user immediately after the destination call of this user was received. It is instead proposed to initially wait for a certain delay time period before the required assignment of a service elevator to the waiting user is carried out.

Among other things, this proposal is based on the realization that conventional destination call controls do not take into account if additional users send a similar destination call soon after the reception of a destination call from a user in the assignment of a service elevator. For example, this can lead to situations, in which multiple users have a similar transportation request within a short time period, but the assignment of service elevators does not take this into account.

For example, a situation may arise, in which multiple users arrive on an identical floor or on nearby floors within a short time period and would like to be transported to similar destination floors. However, an individual common service elevator is not necessarily used for this purpose in a conventional destination call control. This can be attributed to the fact, for example, that a service elevator is already assigned to the first user before it is detected that other users have a similar transport request. However, the service elevator assigned to the first user may not have sufficient free space for accommodating the additional users such that other elevators have to be assigned to the additional users. This potentially impairs the overall transport efficiency of the elevator group. In addition, waiting times for the users may be extended on average for all users.

Since the assignment of a service elevator is not carried out directly after the reception of the destination call sent by the user, but rather only after a delay time period has expired, destination calls sent by other users can also be received while waiting for the delay time period and then taken into account in the assignment of the service elevator. This makes it possible to realize the assignment of service elevators to waiting users in an altogether more efficient manner.

The wait for the delay time period does not necessarily mean that the user sending the destination call has to wait longer for his elevator because a certain waiting time is in most instances required anyway for moving one of the elevators of the elevator group to the waiting floor and the delay time period may be shorter than such a traveling time. Accordingly, the delay time period may be included in the waiting time caused by the traveling time such that the delayed assignment of the service elevator does not have to result in an extension of the waiting time for the user.

According to an embodiment of the invention, it may particularly be taken into account in the assignment of the service elevator how an assignment of service elevators to users sending destination calls can with consideration of additional destination calls received during the delay time period be chosen to the effect that a capacity utilization of the elevator group and/or an average waiting time for users of the elevator group is optimized.

In other words, additional destination calls from other users can be received by an elevator controller, for example, after the destination call of a first user was received and while waiting for the subsequently initiated delay time period. Information derived from these additional destination calls can then be analyzed and evaluated to the effect that an improved assignment of the service elevator can be realized based on the destination call of the first user, as well as on the additional destination calls of the other users, by selecting the respective service elevator from the multiple available elevators of the elevator group.

The analysis and evaluation may take place to the effect that an overall capacity utilization or transport efficiency of the elevator group is optimized. For example, service elevators may be arranged in such a way that users with the same or similar waiting floor and/or the same or similar destination floor are, if possible, jointly assigned to the same service elevator as long as their destination calls were received, for example, during the delay time period initiated by the first destination call. This makes it possible to reduce required traveling paths of elevators of the elevator group and to thereby improve a transport efficiency of the elevator group, as well as to potentially reduce an energy consumption and/or wear on the elevator group.

The analysis and evaluation may additionally or alternatively also take place to the effect that it is attempted to assign service elevators to the waiting users in such a way that the waiting times of the users are reduced on average. At a very high volume of passenger traffic, in particular, it may be advantageous, for example, to not assign a service elevator, which appears to be optimal at this point in time, to each user directly upon the reception of his destination call because this can lead to bottlenecks in the suitable assignment of service elevators in reaction to destination calls arriving shortly thereafter. Instead, it may on average be more advantageous that a user sending a first destination call is assigned a service elevator, which is not considered optimal for this user with respect to its waiting time, based on the information of destination calls from other users arriving shortly thereafter. In this way, the waiting time can be reduced on average for the sum of all users.

According to an embodiment, a duration of the delay time period is longer than a calculation time required for calculating the assignment of the service elevator.

In other words, the delay time period preferably should be significantly longer than the calculation time, which an elevator controller requires, for example due to its technical design, for assigning a service elevator based on information available at the time of the reception of the destination call. The assignment of the service elevator, i.e. the selection which of the multiple available elevators of the elevator group should pick up and transport a waiting user to his destination floor, is typically carried out by an elevator controller, to which different information is made available. The decision on the assignment of the service elevator is in this case realized by means of a calculation, i.e. by means of data processing of the information made available, and until now typically carried out as fast as possible within the technical design of the elevator controller. In this context, the technical design of the elevator controller particularly includes its technical data processing options. The information to be processed for the assignment of a service elevator comprises, among other things, information transmitted with the destination call of a user and information on an instantaneous capacity utilization of the elevator group, particularly with respect to currently transported passengers, as well as already planned traveling paths based on previously received destination calls. A calculation time typically lies between several milliseconds and a few hundred milliseconds.

According to an embodiment of the invention, a duration of the delay time period may be longer than 2 s, preferably longer than 5 s, particularly longer than 10 s or longer than 20 s.

Consequently, the delay time period may on the one hand be sufficiently long for initially waiting for destination calls arriving shortly after the reception of a first destination call and to thereby bundle the assignment of service elevators, for example, based on the information of multiple destination calls. Delay time periods of at least 2 seconds or at least 5 seconds or of at least 10 seconds or 20 seconds, particularly in large elevator systems in tall buildings, appear advantageous in this respect. On the other hand, the delay time period should not be excessively long, for example preferably no longer than 10 seconds or 20 seconds in small elevator systems and preferably no longer than 30 seconds or 50 seconds in large elevator systems, in order to not extend or at least not excessively extend the waiting times for users.

According to an embodiment of the present invention, the proposed method furthermore comprises a calculation of a minimum traveling time that the elevator, which is located closest to the waiting floor indicated in the received destination call at the time of the reception of the destination call, at least requires for traveling to the waiting floor. Alternatively, the method may furthermore comprise a calculation of a minimum traveling time that the elevator, which requires the least modification of its previously planned schedule in comparison with other elevators in order to travel to the waiting floor, at least requires for reaching the waiting floor. A duration of the delay time period is then chosen in dependence on the minimum traveling time.

In other words, the delay time period does not necessarily have to be a permanently predefined duration, but the delay time period may possibly be defined in dependence on conditions that vary during the operation of the elevator group. Such varying conditions particularly may be a minimum traveling time that is required for allowing an elevator, which in the concrete instance presumably is the most suitable elevator, to travel to the waiting floor of the user who has sent a destination call as the service elevator.

The elevator, which in the concrete instance is most suitable as the service elevator, can be selected based on different criteria. For example, the elevator that is currently located closest to the waiting floor and therefore would have the shortest traveling path may be preferred as the service elevator.

However, it would also be possible to use more complex criteria. It would be possible, for example, to carry out a calculation of so-called “costs” that indicate how significantly the schedule of an elevator, which was determined previously based on the requirements existing at that time, would have to be modified in order to pick up the waiting user on the waiting floor and to transport this user to his destination floor. A calculation and comparison of the potentially arising costs for each of the elevators of the elevator group for the instance that this elevator would have to serve as service elevator makes it possible to determine the elevator, which at least at the time of the reception of the destination call would require the least modifications to its previously planned schedule in comparison to other elevators and therefore is a very good candidate for being selected as the service elevator after the expiration of the delay time period.

The delay time period to be waited for can be suitably chosen depending on the duration of the minimum traveling time calculated during the reception of the destination call in a concrete situation. The longer the calculated minimum traveling time required by a most suitable elevator for reaching the waiting floor, the longer the delay time period can generally be selected. In this case, the selected delay time period preferably is significantly shorter than the calculated minimum traveling time.

According to an embodiment of the invention, the duration of the delay time period particularly may be selected in such a way that a sufficient residual duration of the minimum traveling time for enabling the user to reach an elevator door of the selected service elevator remains after the expiration of the delay time period.

In other words, the duration of the delay time period may be selected sufficiently short such that sufficient time for informing the user of the assigned service elevator and allowing this user to walk to the elevator door of the selected service elevator remains after the expiration of the delay time period and the associated assignment of the service elevator. In this case, the residual duration remaining after the expiration of the delay time period until the assigned service elevator actually arrives on the waiting floor naturally may be chosen differently depending on the respective situation. For example, a distance to be traveled by the waiting user to the elevator door of the service elevator may be taken into account in the specification of this residual duration. The residual duration to be observed therefore may amount, for example, to several seconds such as 3 seconds, 5 seconds, 10 seconds or 20 seconds depending on the local circumstances in the elevator group.

According to an embodiment of the invention, the proposed method may furthermore comprise informing the user sending the destination call of the identity of the assigned service elevator after the expiration of the delay time period.

In other words, the user sending the destination call can be informed of the identity of the assigned service elevator as soon as the delay time period has expired such that the user can start walking to the elevator door of the service elevator in a timely manner.

According to an embodiment of the invention, it may be advantageous to send the identity of the assigned service elevator to a personal mobile data processing device of the user, wherein the data processing device should be configured for informing the user of the identity of the assigned service elevator.

In this context, a personal mobile data processing device refers to a device that typically is in the possession of the user, i.e. a device that is carried along by the user and capable of exchanging data with other devices, as well as processing this data. Typical examples of such data processing devices are mobile telephones, smartphones, portable computers, wearables, etc.

For example, a computer program in the form of an app may be installed on the data processing device and instruct the data processing device to communicate with the elevator controller. The term app is an abbreviation for application program. Apps for mobile devices such as smartphones can be obtained from an app store, which is integrated into an operating system of the mobile device, and directly installed on the mobile device. Prior to their use on the data processing device, apps can be downloaded from a storage unit (e.g. a server) or directly retrieved by means of a web browser via the Internet or a network with the aid of cloud technology. For example, the data processing device may transmit its contact data to the elevator controller as soon as the user sends a destination call. To this end, the data processing device may communicate with the elevator controller, for example, via a near-field communication (NFC) or other wireless communication methods. The utilization of near-field communication may provide the advantage of ensuring that only the data processing device of the sending user is located sufficiently close to a communication interface of the elevator controller for transmitting its contact data while the destination call is sent such that the data processing device, to which the identity of the assigned service elevator should subsequently be transmitted after the expiration of the delay time period, can be positively determined.

In this way, the user waiting for the assignment of a service elevator after sending his destination call can be easily and individually informed of the assigned service elevator by means of his personal mobile data processing device. In this case, the information may be communicated visually, e.g. in the form of a display on a display unit, auditory, e.g. by outputting a voice message, or in another suitable way.

However, other options for informing the user of the identity of the assigned service elevator are basically also available. For example, the user may in reaction to sending the destination call receive an identification number or the like, with respect to which the information regarding the identity of the assigned service elevator is subsequently transmitted after the expiration of the delay time period. For example, the identification number and the identity of the assigned service elevator may be displayed on a display unit. The above-proposed utilization of the personal data processing device of the user for communicating the identity of the assigned service elevator can also contribute to eliminating the need for corresponding display units or the like on the elevator group.

According to an embodiment of the invention, a personal mobile data processing device of the user may furthermore be configured and used for generating the destination call to be sent by the user.

In other words, the data processing device of a user, e.g. in the form of a smartphone, may be configured for generating the destination call with the aid of an app installed thereon. To this end, the user can appropriately input the waiting floor, on which he is currently located, and the destination floor, to which he would like to be transported, on his smartphone. Alternatively, the smartphone may automatically determine the current position of the user. For example, the smartphone may for this purpose communicate with the elevator controller, preferably via near-field communication, in order to detect on which floor it is currently located. Position data such as data of a global or local GPS system may alternatively be used for this purpose. The destination floor may optionally also be determined in an automated manner. The destination floor may be determined, for example, based on the habits of the user.

According to other embodiments of the invention, the personal mobile data processing device of the user may furthermore be configured for carrying out other actions as part of a cooperation with the elevator group or with its elevator controller, respectively. Such actions may be diverse and comprise, for example, (i) confirming the receipt of the destination call by outputting a signal via the data processing device; (ii) informing the user of the remaining waiting time until the service elevator arrives on the waiting floor by outputting a signal via the data processing device; and/or (iii) informing the user of an assigned waiting area for waiting until the service elevator arrives on the waiting floor by outputting a signal via the data processing device.

In the first case, the user can send his destination call to an elevator controller of the elevator group either directly, i.e. for example by actuating a button or a keypad that forms part of the elevator group, or indirectly, i.e. for example by manually inputting the destination call on his personal mobile data processing device or by means of a destination call automatically generated by the data processing device. The elevator controller can subsequently confirm the correct reception of the destination call in that a signal is transmitted to the personal data processing device of the user and the data processing device then suitably informs the user of the correct reception of his destination call. In this way, the user already can be notified at least of the fact that his destination call was correctly received immediately after his destination call was sent, i.e. while still waiting for the delay time period and therefore not yet transmitting any information on the assignment of the service elevator to the user.

In the second case, the user can be provided with information on how long he will presumably have to wait for the arrival of the service elevator on his waiting floor, preferably subsequent to the assignment of the service elevator after the expiration of the delay time. To this end, the elevator controller can analyze the current position of the service elevator and optionally an already calculated schedule up to the arrival on the waiting floor, i.e. including any intermediate stops, and calculate the traveling time to the waiting floor based on this analysis. Corresponding information can be transmitted to the personal data processing device of the user and output thereby, e.g. visually or auditory. In this way, the user can potentially use the remaining waiting time in a suitable manner.

In the third case, the elevator controller can indicate the location, i.e. the waiting area, in which a user preferably should wait for the arrival of the service elevator after sending his destination call. The waiting area may be chosen adjacent to the elevator group depending on the local circumstances in the building. The waiting area can potentially be chosen individually for each user. For example, the waiting area may be chosen in such a way that a user already waits for the arrival of the assigned service elevator in the vicinity thereof. In this case, the waiting area may be chosen in such a way that no other passengers are disturbed or impaired when they want to walk to their assigned service elevators. Entertainment or promotional offers adapted to the user may optionally be presented in the waiting area.

An elevator controller according to an embodiment of the second aspect of the invention is configured for suitably controlling multiple elevators of an elevator group in accordance with the method described herein by initially waiting for the delay time period after the reception of a destination call from a user before assigning a suitable service elevator to this user. In this case, the elevator controller is configured for receiving additional destination calls from other users during the delay time period and for taking these additional destination calls into account in the calculation of the assignment of a service elevator to the first-mentioned user.

In this case, the elevator controller may basically be realized with the aid of hardware only. It is alternatively deemed advantageous to realize the elevator controller such that it can be programmed by means of software. To this end, the elevator controller may comprise a central data processing unit (CPU), i.e. for example a processor, as well as storage mediums, e.g. for electronically or magnetically storing data. The elevator controller may furthermore comprise wire-bound or wireless interfaces, by means of which data can be exchanged with other devices such as the aforementioned personal mobile data processing device of a user. The interfaces may allow data communication in accordance with different transmission protocols and technologies such as WLAN, Bluetooth, NFC, etc. Man-machine interfaces may also be provided.

A programmable elevator controller can be suitably programmed with the aid of software in the form of a computer program product such that it carries out or controls embodiments of the method described herein. The computer program product may be formulated in any computer language that can be read by a computer.

The computer program product may be stored on a machine-readable medium such as a flash memory, a CD, a DVD, a ROM, a PROM, an EPROM or the like. The computer program product may alternatively also be stored on one or more servers, from which it can be retrieved and executed or downloaded via a network, particularly the Internet. The servers may form a data cloud (cloud). For example, the use of <<Internet of Things>> (IoT) in the field of smart buildings would be conceivable. In this way, physical systems can be economically linked by means of the Internet and cloud technology. Remote monitoring makes it possible to analyze data of the system in real time and to interact with the system in real time.

It should be noted that a few of the potential characteristics and advantages of the invention are described herein with reference to different embodiments, particularly with reference to the inventive control method or with reference to an inventive elevator controller. A person skilled in the art recognizes that the characteristics can be suitably combined, transferred, adapted or interchanged in order to arrive at additional embodiments of the invention.

Embodiments of the invention are described below with reference to the attached drawings, wherein neither the drawings nor the description should be interpreted in a restrictive sense.

### DESCRIPTION OF THE DRAWINGS

FIG. 1 shows an elevator group, in which an embodiment of the inventive method can be implemented, and

FIG. 2 shows a schematic representation of a method for controlling an elevator of an elevator group.

The figures are merely schematic and not true-to-scale.

### DETAILED DESCRIPTION

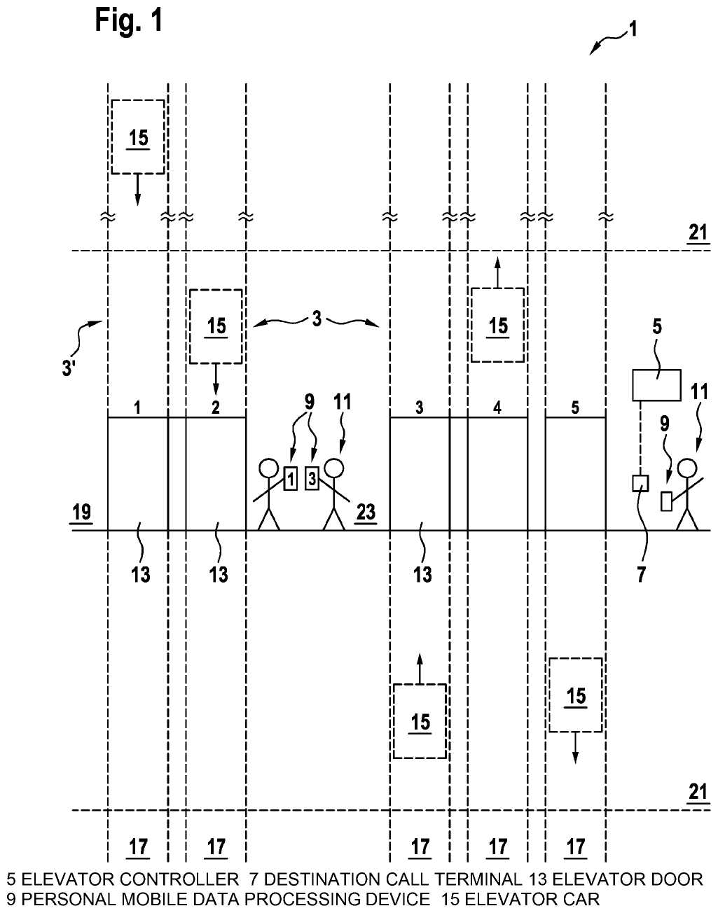

FIG. 1 shows an elevator group 1 with five elevators 3. Each of the elevators 3 comprises an elevator shaft 17, within which one respective elevator car 15 that can move vertically. Each of the elevator cars 15 is moved by a (not-shown) drive. The drives of the different elevators 3 are controlled by a common elevator controller 5. In this case, the elevator controller 5 also coordinates schedules of the multiple elevators 3 in order to transport users 11 as efficiently as possible with the aid of the elevator group 1 and to minimize waiting times. It is proposed that the users 11 also indicate the destination floor 21, to which they would like to be transported, when they call an elevator 3 of the elevator group 1 while waiting on a waiting floor 19. The elevator controller 5 can efficiently plan the schedules of the elevators 3 of the elevator group 1 based on this information in a destination call.

In a conventional destination call system, it was until now attempted to carry out the calculation of a service elevator 3′ to be assigned to a user 11, i.e. the selection of an elevator 3′ from the plurality of elevators 3 for transporting the user 11 sending the destination call, as quickly as possible in order to inform the user 11 of the identity of the assigned service elevator 3′ as soon as possible. Since the calculation should be carried out quickly, it is in this case not possible to take into account any future events such as future elevator calls by other users 11, which take place after the input of the present destination call.

It is therefore proposed to modify the mode of operation of the elevator controller 5 to the effect that a service elevator 3′ is not assigned immediately after the reception of the destination call in the destination call method carried out by the elevator controller. Instead, the elevator controller should initially wait for a delay time period that may amount, for example, to a few seconds. A suitable service elevator 3′ is not calculated and assigned to the waiting user 11 based on the previously transmitted destination call until this delay time period has expired. Information transmitted to the elevator controller 5 by other users 11 after the reception of the destination call of the first user 11, but still during the subsequent delay time period, is also taken account in this case. In this way, service elevators can be assigned to individual users 11 more appropriate to the situation.

An embodiment of the method for controlling the elevator group 1 proposed herein is described below with reference to an example.

The elevator controller 5 monitors if a user 11 sends a destination call to the elevator controller continuously or within short time intervals. For example, a user 11 can approach a destination call terminal 7 in order to send such a destination call. At least one destination call terminal 7 is located on each floor of a building serviced by the elevator group 1. At the destination call terminal, the user 11 can input his destination call, for example, into his personal mobile data processing device 9 in the form of a smartphone. A special app is installed on the smartphone and configured for receiving the information on the destination call desired by the user 11 on the one hand and for forwarding this information to the elevator controller 5 on the other hand. To this end, the app can request information on the current waiting floor 19 and on the desired destination floor 21 from the user 11. Alternatively, one or both of these types of information can also be generated automatically, for example, in that the app requests additional information from the elevator controller 5 and/or analyzes elevator utilization habits of the user 11. The destination call information is then preferably transmitted to the elevator controller 5 in a wireless manner. For example, near-field communication (NFC) may be established between the smartphone 9 and the destination call terminal 7 in order to thereby transmit the information on the current waiting floor 19, as well as the information on the desired destination floor 21, to the elevator controller 5. The utilization of near-field communication, in which data and signals can only be transmitted over short distances, i.e. for example less than 1 m, makes it possible to ensure that destination calls can only be sent by users 11 who are actually located near the elevator group 1.

The elevator controller 5 subsequently registers the received destination call. The elevator controller 5 optionally sends a signal to the smartphone 9 of the user 11 in order to confirm the reception of the destination call. The smartphone 9 can subsequently display or output corresponding information for the user 11.

A delay time period is started when the destination call is received. A duration of the delay time period may either be permanently predefined, i.e. for example amount to 20 s, or calculated specific to the situation, i.e. for example chosen longer or shorter depending on how far the next elevator 3, which could serve as the service elevator 3′, is located from the waiting floor 19.

Although the elevator controller 5 can already carry out initial calculations during the delay time period in order to select potential candidates for the service elevator 3′ to be assigned, a final assignment of the service elevator is not yet carried out during the delay time period.

Instead, the elevator controller 5 potentially can initially transmit a signal to the smartphone 9 of the user 11, based on which the smartphone displays or outputs a request for the user to move to a waiting area 23 and to wait for further information in this waiting area.

During the delay time period, the elevator controller 5 can analyze options for the selection of an elevator 3 that is suitable as the service elevator 3′ and then actually select one of the elevators 3 as the service elevator 3′, as well as assign this service elevator to the waiting user 11 at the end of the delay time period. In this case, not only the destination call of this user 11 is taken into account, but also destination calls that are sent by other users 11 at a later point in time within the delay time period. The assignment of the service elevator 3′ is completed after the expiration of the delay time period. The delay time period may either be a permanently predefined duration or adapted to the respective situation. For example, the elevator controller 5 can stop calculating an optimal assignment of the service elevator 3′ as soon as it assumes that an optimal compromise between the elevator assignment and the waiting times of users 11 was found.

The user 11 can subsequently be informed of the assigned service elevator 3′. For example, the elevator controller 5 can send corresponding information to the personal mobile data processing device 9 of the user 11, whereupon this data processing device displays or outputs the corresponding information for the user 11.

As a supplement, the elevator controller 5 can calculate a waiting time that remains until the service elevator 3′ presumably reaches the waiting floor 19. In this case, the instantaneous position of the elevator car 15 of the service elevator 3′, as well as potentially planned intermediate stops, can be taken into account. If applicable, the elevator controller 5 can prompt the user 11 to move to an entrance area near the elevator door 13 of the service elevator 3′ in a timely manner by transmitting suitable signals.

The corresponding information can be transmitted, for example, from the elevator controller 5 to the smartphone 9 of the user 11 via a wireless data link. Data transmission technologies such as WLAN (Wi-Fi), which allow a data transmission over greater distances, e.g. over more than 10 m or even more than 20 m or 50 m, preferably are used in this case such that users 11 can move within a sufficiently large radius while waiting.

As soon as the elevator car 15 of the service elevator 3′ has reached the waiting floor 19 and the elevator door 13 has been opened, the user 11 can enter and the elevator car 15 can then travel to the desired destination floor 21.

In a special embodiment, the elevator controller 5 can register if the user 11 actually has entered the assigned service elevator 3′. An unnecessary movement of the elevator car 15 can be prevented if this is not the case.

In another special embodiment, the calculation process for assigning the service elevator 3′ may be carried out in two stages. For example, a group of elevators 3, which already appear eligible as potential service elevators at the beginning of the delay time period, may be identified in a first stage. The service elevator 3′ to be actually assigned may then be selected from this group in a second stage after the expiration of the delay time period, wherein the additional information on subsequently received destination calls obtained during the delay time period can also be taken into account.

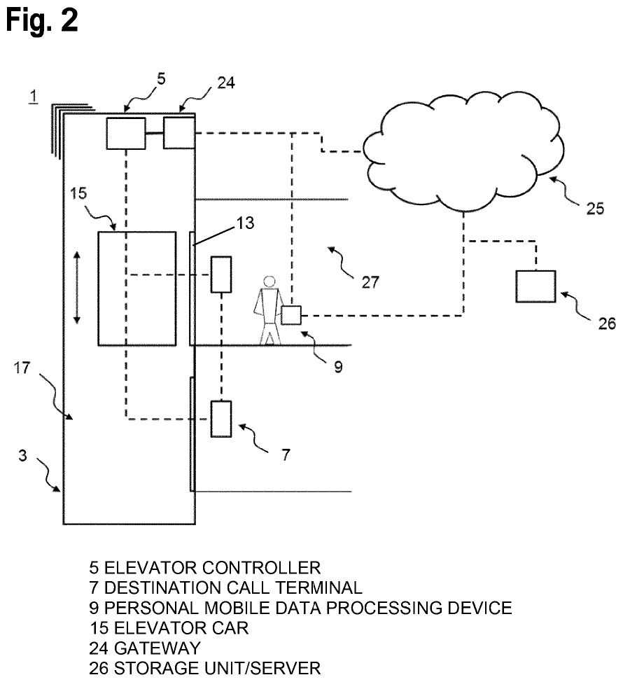

FIG. 2 schematically shows an exemplary system for carrying out the inventive method for controlling an elevator group 1. In this case, an elevator 3 of the schematically indicated elevator group 1 is controlled by an elevator controller 5, wherein an elevator car 15 of the elevator 3 can move up and down in an elevator shaft 17 in order to transport passengers to different destination floors. A gateway 24 enables the elevator controller 5 to communicate with the outside world, for example with a mobile device 9 of a passenger that may likewise represent a destination call terminal and is connected to the gateway directly via a wireless link (e.g. Bluetooth or WLAN) or indirectly via the Internet and/or cloud technology. Alternatively, the gateway may be respectively connected to other storage units or control devices (e.g. a server) 26 via the Internet and particularly via cloud technology 25. The different data communications 27 are illustrated with broken lines in FIG. 2. Such data communications may be wire-bound or wireless communications.

In order to send a destination call, a passenger can use a destination call terminal 7, e.g. a COP (car operation panel) within the elevator car 15 or a LOP (lobby operation panel) on a floor, or a mobile device 9 such as a smartphone. An application (app) is typically installed on the mobile device 9 for this purpose, wherein the app is downloaded to the mobile device 9 by means of a web browser or directly retrieved from a storage unit or server 26 via cloud technology prior to its use.

According to the invention, the elevator controller 5 does not have to immediately carry out a received destination call, but may rather wait for a certain delay time period in order to optimize the entire method. The delay time period for a calculated minimum traveling time of an elevator car 15 to a waiting floor is typically predefined in the form of a constant value. In addition, the delay time period can be respectively adapted or updated at any time by utilizing cloud technology (e.g. calculation of the delay time period on a remote computer system/server) in order to respectively optimize the overall waiting time or traveling time for passengers. To this end, the elevator group 1 is remotely monitored and dynamically controlled in accordance with current passenger traffic situations or in accordance with an elevator operating state. In the inventive method, the delay time period should be significantly shorter than the calculated minimum traveling time of the elevator car.

Other than that, it should be possible to define the delay time period in terms of a usage priority of passengers. No delay time period or a shorter delay time period is defined for a passenger who has a higher priority to travel with the elevator 3 as soon as this passenger was identified by the elevator controller 5. The so-called usage priority may be assigned, e.g., in dependence on a work function, work position, work task or an appointment calendar of passengers, etc.

In conclusion, it should be noted that terms such as “having,” “comprising,” etc. do not preclude any other elements or steps and that terms such as “a” or “an” do not preclude a plurality. It should furthermore be noted that characteristics or steps, which were described above with reference to one of the exemplary embodiments, can also be used in combination with other characteristics or steps of other above-described exemplary embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

### REFERENCE LIST

1 Elevator group
3 Elevator
3′ Service elevator
5 Elevator controller
7 Destination call terminal
9 Personal mobile data processing device
11 User
13 Elevator door
15 Elevator car
19 Elevator shaft
19 Waiting floor
21 Destination floor
23 Waiting area
24 Gateway
25 Network/cloud
26 Storage unit/server
27 Data communication

1-15. (canceled)

16. A method for controlling an elevator group having a plurality of elevators on the basis of destination calls sent by users to the elevator group, the method comprising the steps of:
receiving a destination call that contains at least information regarding a waiting floor on which a user sending the destination call is waiting and regarding a destination floor to which the user should be transported;
waiting for a delay time period;
assigning one of the elevators of the elevator group as a service elevator after the delay time period has expired and controlling the service elevator to pick up the user on the waiting floor and transport the user to the destination floor; and
wherein the service elevator is assigned with consideration of information contained in destination calls that are received during the delay time period.

17. The method according to claim 16 including assigning as the service elevator a one of the elevators of the elevator group that optimizes at least one of a capacity utilization of the elevator group and an average waiting time for users of the elevator group.

18. The method according to claim 16 wherein a duration of the delay time period is longer than a calculation time required for calculating the assignment of the service elevator.

19. The method according to claim 16 wherein a duration of the delay time period is longer than two seconds.

20. The method according to claim 16 including:
calculating a minimum traveling time required to reach the waiting floor in the destination call information for a one of the elevators of the elevator group that either is located closest to the waiting floor when the destination call is received or requires a least modification of a previously planned travel schedule in comparison with other elevators of the elevator group in order to travel to the waiting floor; and
choosing a duration of the delay time period in dependence on the calculated minimum traveling time.

21. The method according to claim 20 including choosing the duration of the delay time period to provide a sufficient residual duration of the minimum traveling time to enable the user to reach an elevator door of the assigned service elevator after an expiration of the delay time period.

22. The method according to claim 16 including informing the user of an identity of the assigned service elevator after an expiration of the delay time period.

23. The method according to claim 22 including transmitting the identity of the assigned service elevator to a personal mobile data processing device of the user and wherein the data processing device is adapted to inform the user of the identity of the assigned service elevator.

24. The method according to claim 16 including generating and sending the destination call with a personal mobile data processing device of the user.

25. The method according to claim 16 including configuring a personal mobile data processing device of the user for carrying out at least one of the following actions:
confirming a receipt of the destination call by outputting a signal via the data processing device;
informing the user of a remaining waiting time until the service elevator arrives on the waiting floor by outputting a signal via the data processing device; and
informing the user of an assigned waiting area for waiting until the service elevator arrives on the waiting floor by outputting a signal via the data processing device.

26. An elevator controller controlling an elevator group having a plurality of elevators and wherein the elevator controller is adapted to perform the method for controlling according to claim 16.

27. An elevator group comprising:
a plurality of elevators: and
an elevator controller according to claim 26 controlling the elevators.

28. A computer program product containing machine-readable instructions, wherein upon execution on a programmable elevator controller the instructions prompt the programmable elevator controller to perform the method according to claim 16.

29. The computer program product according to claim 28 wherein the computer program product is stored in a storage unit and is retrieved from the storage unit by the programmable elevator controller via a network.

30. A non-transitory machine-readable medium on which the computer program product according to claim 28 is stored.
